(19) United States
(12) Patent Application Publication
(10) Pub. No.: US 2006/0084430 A1
(43) Pub. Date: Apr. 20, 2006

(54) System and method for categorizing information into zones to determine delivery patterns

(76) Inventor: Eric M. Ng, Daly City, CA (US)

Correspondence Address: Eric Ng, # 707, 3430 E. Jefferson Ave., Detroit, MI, 48207, US

(21) Appl. No.: 10/964,209

(22) Filed: Oct. 14, 2004

(51) Int. Cl. H04Q 7/00

(52) U.S. Cl. 455/426.1

(57) ABSTRACT

The present invention relates to a system and method of exchanging information that can be specific to a person and their current location. The method uses the location of a wireless device held by a stakeholder, i.e. a person that is related to the information, and routes information to the zone they are in. The portable wireless device is used to track the location of the stakeholder, and also provides methods for updating relevant information while the stakeholder is located in a specific zone.

### FIELD OF INVENTION

The present invention relates generally to the integration of wireless electronic devices into a working environment. More specifically it deals with a method of retrieving relevant information based on identifying and locating a zone of a specific wireless device.

### BACKGROUND OF THE INVENTION

Within most working environments there is now extensive integration between wireless devices and normal working activities. These wireless devices can function as both phone and data devices for providing a full range of services. Wireless devices can include smaller handheld devices, like 802.11-based Personal Digital Assistants (PDA), Bluetooth-based Phones, headphones and small personal devices like ear-buds, or Smartphones that have both phone and Personal Information Managers (PIM) components. Alternatively the wireless device could be larger devices like 802.11-capable laptop computers or 802.11-based sub-notebook computer.

The number and variety of 802.11 standards can be accessed at the IEEE web site: http://standards.ieee.org/getieee802/802.11.html, which provides access to the original 802.11b, and newer standards 802.11a, 802.11g and others. This technology is also frequently called Wi-Fi, but this is an industry term that effectively means the same thing. There are other upcoming standard for broadband wireless data exchanges, called WiMAX. Information is available from, i.e. http://www.wimaxforum.org/about/faq that describes WiMAX in greater detail. The term Smartphone is another industry term that has been created to describe phones that have PDA-like functionality, including cameras, MP3 players and video phones.

These wireless devices can provide desktop phone functionality and full e-mail capabilities as well. With the arrival of wireless LAN and wireless Broadband networks like 802.11b, 802.11a, 802.11g, Bluetooth, WiMax and other similar standards an entirely new class of applications are appearing. The appearance of wireless LANs (WLANs), Personal LANs (PANs) in a workplace ‘campus’ setting means a new level of freedom when exchanging information.

An exemplary example of wireless device access would be within a hospital setting. Normally in hospitals cellular phones are not allowed, and can even be disabled using third-party software, e.g. products from Cell Block Technologies Inc. (http://www.cell-block-r.com). This means that 802.11 access points would be ideal for building coverage areas throughout the hospital. Nurses, doctors, IV specialists and emergency personnel are wearing traditional-looking 802.11-based wireless phones to reach personal within the hospital. Voice only solutions that would work over an 802.11 network include products from Symbol Technologies, NetVision, Nortel Networks and others. Also available are solutions from a company called Vocera, which provides a wearable communications badge that allows hands-free communications in a hospital setting. There are also data-stations within the hospital that can be rolled into a patient room to receive patient information before an operation, like drug allergies, operation history, etc. These are linked directly to 802.11 access points to exchange information with back-end patient database records.

These solutions solve specific problems by offering limited functions in a workplace environment but fail to offering broader services. A doctor or nurse using a voice over Internet Protocol (VoIP) phone device would be unable to exchange data with another doctor or nurse. Generally these voice-centric solutions are very costly for doctors and nurses as they can require long voice communications to exchange patient information that could be exchanged faster using other methods. Users of the data-stations are able to roll full-scale computers, with battery back-up units and 802.11 communications equipment, into a room but they are unable to communicate critical information to anyone while using this equipment.

In a legacy hospital environment there are many communications challenges to be faced. Even though a nurse can call a doctor using an 802.11 VoIP phone, they can't exchange actual information. Therefore the doctor is still forced to travel to the nursing station in order to get access to patient information. This leads to major inefficiency when there is no other information to be exchanged between doctors and the nursing staff. There must be a more efficient solution for providing the doctor with the information they need to access their patients in a timely manner.

Previous solutions do not address the ability to communicate just-in-time patient information to those that need and care about the information. Whether the information is a broken intravenous drip machine (IV) or a patient pressing their call button, it would be useful to have the ability to exchange information using 802.11 in a timely fashion to those that care about the information. Therefore there is still a need for a system that can deal with the timely exchange of urgent data in a workplace environment, where W-LAN technology is available. A system is required that can take advantage of the 802.11 W-LAN network, and communicate central information to those that directly care about that information (stakeholders). When time is money, or time can help to make timely life and death decisions, there is a need to automate the workplace and find a way to exchange this information in a timelier manner.

### SUMMARY

According to one aspect of the invention, the present invention provides a real-time exchange of categorized data within a W-LAN environment so that stakeholders receive that information when they enter W-LAN coverage areas. The categorized data can be specialized data for a hospital, nursing home or a campus of buildings that share a common name and infrastructure. Stakeholders can be categorized as anyone that has a vested and legitimate interest in the information being exchanged, like hospital worker, nurse, doctor or technician. The term W-LAN can refer to any wireless technology that can provide coverage to a common set of company locations. These locations can be physically close or distant, but they share a common data access method and security method. These wireless networks technologies could include Bluetooth, 802.11b, 802.11a, 802.11b, (i, r or others), other spread spectrum technologies like WIMAX, or a collection of several W-LAN regions to create a community or network of W-LAN service areas. The coverage areas are broken into regions, which are termed zones in this application. By placing a zone identifier in the information it is possible to connect the zone and the information. Then, when required for security, a Stakeholder can also be added to the information to further limit its access. A Stakeholder could be viewed as an employee, or an associate to the company that can justifiably look and review the information being delivered.

According to one aspect of the present invention, there is a system for exchanging workplace data within a W-LAN environment where the information is categorized into a plurality of W-LAN zones that represent wireless coverage regions within the workplace. The categorized information is then associated to various stakeholders of that information to determine delivery patterns. As stakeholders enter a zone the information is delivered to them in an automatic and real-time way so they can use the information while in the zone.

According to another aspect of the present invention, there is a system for exchanging workplace data within a W-LAN environment where a stakeholder enters a W-LAN coverage region, receives information for that region and can resend a message with the information to another stakeholder.

According to another aspect of the present invention, there is a system to connect external peripheral devices into the W-LAN environment where a piece of equipment that is permanently within a W-LAN coverage region, can cause information related to that region to be forwarded to another stakeholder of that information.

### BRIEF DESCRIPTION OF THE DRAWINGS

Certain embodiments of the present invention will now be described, by way of example only, with reference to the attached figures, wherein:

FIG. 1 is graphical illustration a generic business environment including W-LAN coverage.

FIG. 2 is a graphical illustration of how the invention can be applied to a generic business environment as shown in FIG. 1.

FIG. 3 is a graphical illustration that shows a specific embodiment within a hospital environment where the invention could be used.

FIG. 4 is a graphical illustration of a sample database layout used for correlating data for delivery.

FIG. 5 is a flow chart depicting the preparation and pre-scanning done by the Data Correlation Module with database information.

FIG. 6 is a flow chart depicting the basic operation of the Data Correlation Module with incoming events and data.

FIG. 7 is a flow chart of depicting the basic operation of the wireless device with incoming events and data.

### DETAILED DESCRIPTION OF THE INVENTION

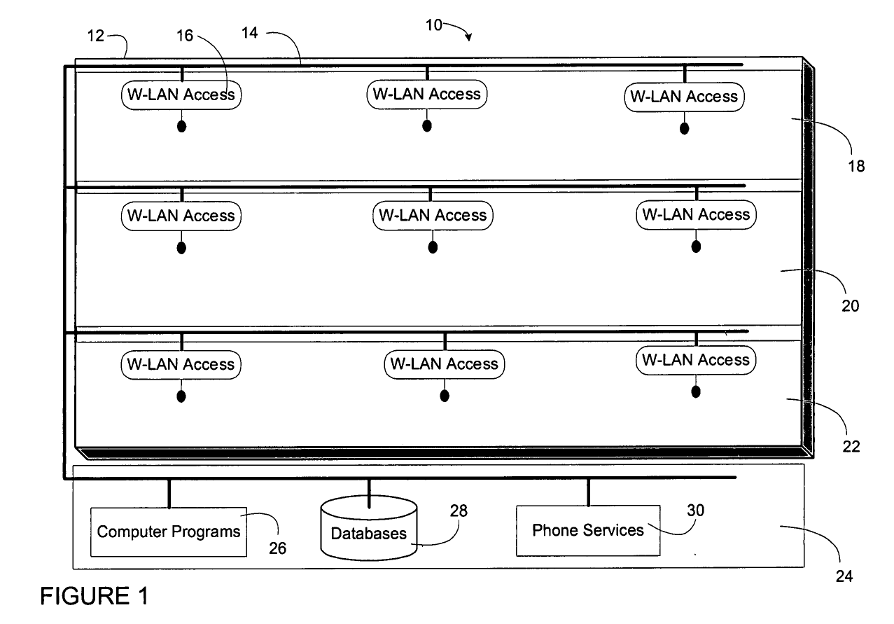

Referring now to FIG. 1, there is a graphical illustration of a generic business environment including W-LAN coverage. The system environment of the invention is illustrated by 10. This environment could be a hospital or any combination of buildings to make up a campus environment. In this example one building 12 is shown with one IT Center 24 located either inside the building or via a link to another building. This does not limit the invention to one building, but it can operate through one or more buildings all linked in various ways to form a campus environment. A campus environment 10 is most often characterized with common shared data, common phones systems, free exchange of company information and a common security plan for all data within the campus. In this example there is one building shown 12, with Local Area Network (LAN) support 14 running through the entire building 12. LAN support is most often made up of Ethernet cable or fiber running high-speed Ethernet protocols. In this illustration each floor has several W-LAN (wireless LAN) access points 16 that cover all floors (18, 20 and 22). In this illustration only three floors are shown but there could be many more. The LAN cable 14 connect computers, printers, W-LAN access points and other electronic equipment to each other and to the IT Center 24. This LAN 14 could also connect machinery and monitoring equipment to the IT Center 24. The IT Center 24 could be within the building 12, or in another building operated on behalf of the company. The IT Center 24 contains commonly shared data running on database-capable computers 28. This area can also contain phone services 30, like phone lines. Most importantly commonly shared software programs 26 can operate in the IT Center 24.

In the examples to follow the application will be focusing on a hospital environment. This choice should not limit the scope and applicability of the patent to just this environment, but all business and companies that have similar features.

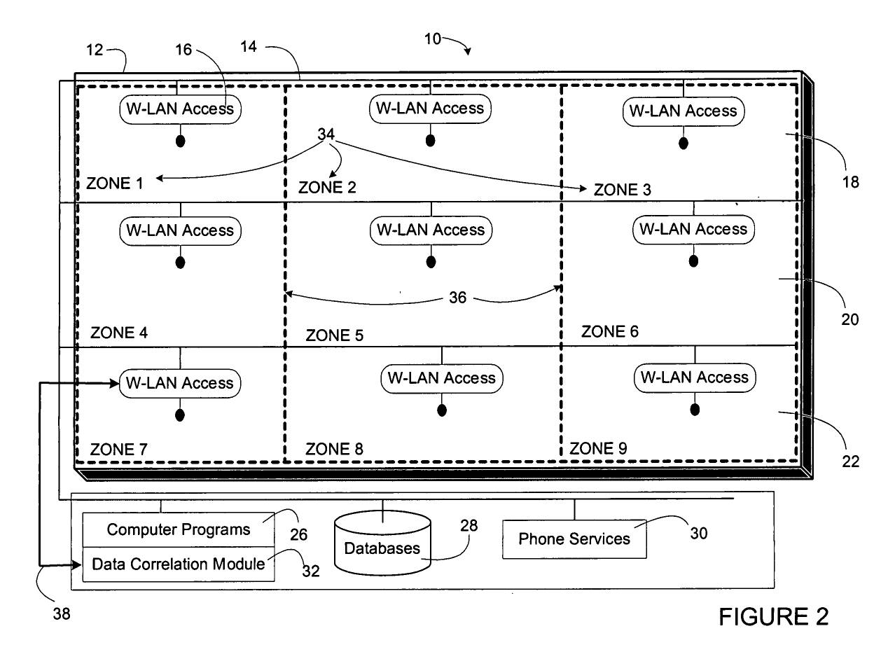

Referring now to FIG. 2, there is a graphical illustration of how the invention can be applied to a generic business environment as shown in FIG. 1. In this illustration a new software program has been identified as part of the IT Center's 24 software systems. This program, called the Data Correlation Module 32, is used to track movement within defined zones 34. The dashed lines 36 are used to define an arbitrary boundary between zones 34 that generally related to coverage regions. As the coverage for a given W-LAN Access Point 16 becomes too weak to support communications, the zone boundary 36 is reached. Therefore each arbitrary zone 34 has a direct correlation to the many W-LAN Access Points 16 located throughout the building 12. One method for the Data Correlation Module 32 to determine the currently connected clients on a W-LAN Access Point 16 would be to use Simple Network Management Protocol (SNMP) to monitor current activity on the node. SNMP would effectively allow for large amounts of status information to be retrieved from each W-LAN Access Point 16, so that the Data Correlation Module 32 could easily track arriving an departing clients.

In an exemplary embodiment of the invention, the zones 34 are defined to help identify regions of the building 12. Different zones are established to provide a grid of zones 34 that connect physical regions of the building 12 with W-LAN 16 coverage regions. The grid does not have to be square, or of a specific design, the grid illustration is only for visual convenience. For example, within Zone 5 (36) any movement of people, information, equipment and resources in and out of the zone 36 will be tracked either manually or automatically. In this example if a machine is placed in Zone 5 (36) this could be manually typed into a database 28, or it could have a bar code scanned into the database 28 each time a machine is installed. Similarly, in the hospital example, if a patient was moved into Zone 5 (36) this information could be placed on the patient's database record 28 that is associated to every patient that is admitted into the hospital 12. The goal of the zones 34 is to group important or related informational elements for those people that care about the information.

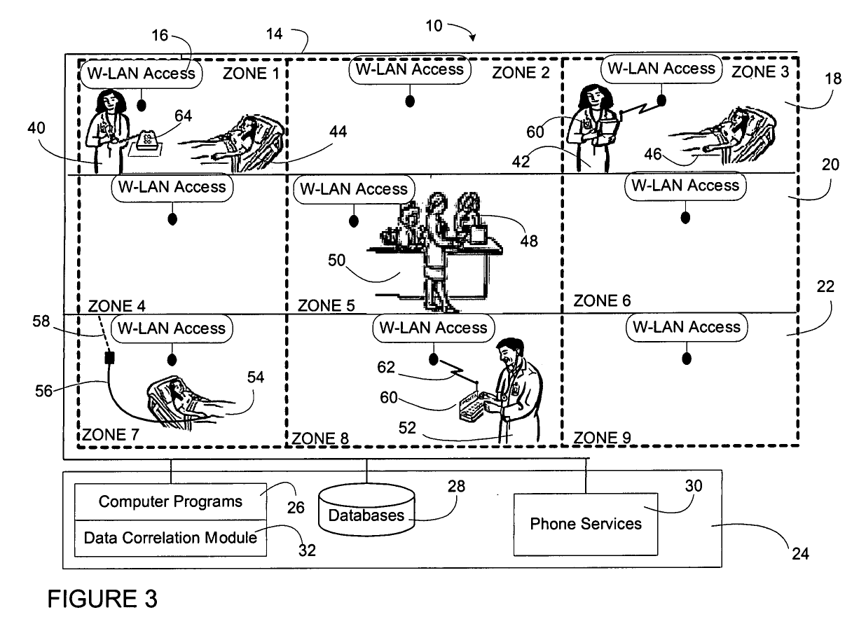

Referring now to FIG. 3, there is a graphic illustration that shows a specific embodiment within a hospital environment where the invention could be used. In this illustration, the hospital 10 is made up of 9 zones, labeled 1 through 9. Naturally, for any given hospital environment 10, there could be greater or lesser quantity of zones than the number presented, depending on the size and structure of the hospital. The hospital is filled with nurses 40, 42 that walk through the hospital 10 visiting patients 44, 46. There are also nurses 48, which reside at the nurse's station 50. Doctor 52 is also moving through the hospital visiting patients 54 as needed to understand their patients 54 condition and what they need.

In this embodiment as the doctor 52 enters the hospital he activities a wireless device 60 through the use of radio frequency (RF) signals 62, for use with the W-LAN Access points 16 located throughout the hospital 10. The doctor 52 either already owns a wireless device 60, or they are able to acquire one from the hospital, for example a loaner pool for the duration of their visit in the hospital 10. Also during their shifts, nursing staff 42, IV Staff, emergency room staff and others are also able to acquire wireless devices 60.

On these wireless devices 60, doctors 52, nurses 42 and others are able to identify themselves and acquire a profile from the hospital 10. The profile is refers to their login privileges and rights to access certain types of information within the hospital records. The login information is delivered to the Computer Programs 26 running in the IT Center 24. As described earlier, the doctor 52 and some number of the hospital staff are considered stakeholders for certain types of information, like patient information.

Instead of going to the nurse's station 50 on the middle floor 20, as described as a limitation in the background section, the doctor 52 gets a summary of his patients (44, 46 and 54) from his wireless device 60. He stops on floor 22, as he knows he has a patient 54 there. As the doctor 52 reaches the floor 22 and walks towards zone 7, the new Data Correlation Module 32 will track his progress. As the doctor 52 passes zone 9 and zone 8, the Data Correlation Module 32 will look at for any patients that are assigned to this doctor 52 in each of those zones. In this example, there are no additional patients, so no data is delivered during his walk on this part of the floor. However, as the doctor 52 reaches zone 7 the Data Correlation Module 32 delivers the patient's 54 information to the doctor's 52 wireless device 60. This is because the Data Correlation Module 32 has already created a correlation table that associated all patients, with zones and stakeholders. Since the doctor 52 was a stakeholder (probably the admitting doctor) and he was entering the zone for his patient, the information was delivered to his wireless device 60. Naturally the patient's 54 information may have already been on the wireless device 60, in the cache and is simply updated and brought to the foreground for the doctor 52 to see. In this way the automatic process of having the most current patient 54 information always on the screen when you need it makes the doctor's 52 life much easier.

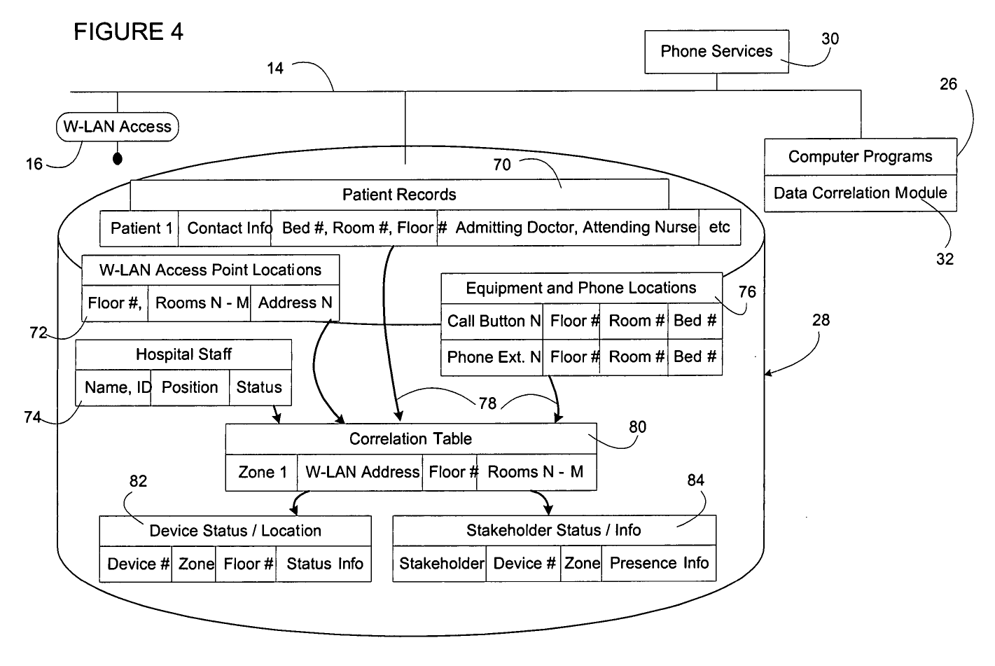

Also within this information that the doctor 52 receives, will be any notes added by nurses (40, 42, or 48) or other hospital staff, that could be attending the patient 54. Periodically through the day as any of the nurses (40, 42, 48) make notations in the patient's 54 record, it is reflected in the main patient database 28. The database 28 within the IT Center 24, comprises many databases (some illustrated in FIG. 4), these can including patient databases, hospital staff databases, W-LAN Access Point assignment databases, equipment and phone allocation databases, drug database, testing center database, just to name a few. In an exemplary embodiment if a doctor 52 is in the zone 7 when the patent's 54 record changes, the doctor's 52 wireless device 60 is notified and the record is pushed to the wireless device 60 immediately. Not only is the record changed, but the doctor 52 is given a special alert on the wireless device 60 so that he knows immediately that something has been added to the patient's 54 record. In this novel way the Data Correlation Module 32 tracks both information changes and the location of stakeholders within zones. It then is able to correlate the changed information to the stakeholder when they are in the zone that the information is assigned to. If the information is assigned to several zones then the Data Correlation Module 32 is able to track the presence of stakeholders in several zones simultaneously.

If the doctor 52 has many patients on this floor 22, all the names and records are provide to the doctor's 52 wireless device 60 in a list with their room numbers. The doctor 52 can then select the closes patient 54 to visit and open up their record on the wireless device 60. During the visit, or once he is finished reviewing the patient's 54 condition, the doctor 52 is then able to update the patient's 54 record in near-real time. This also avoids carrying around the patient's 54 chart when others might need it. Each change that is made to the patient's 54 database record is recorded with the identity of the person making the modification. Therefore a full record of kept of every change made by every person that has access to the record. When the doctor 52 is done with the patient 54, he can move to another floor (18, 20) and the process continues.

In FIG. 3 there is another exemplary embodiment of the invention within a hospital setting. In this embodiment a nurse 42 has entered zone 3 to see a patient 46. When the nurse 42 enters the patient's 46 room the Data Correlation Module 32 knows that the patient 46 has been assigned to zone 3. Therefore when the nurse 42 enters zone 3 her wireless device 60 receives the current patient 46 information out of the database 28. During her routine visit the nurse 42 discovers that there is an urgent situation that needs addressing. This action could require the doctor's 52 approval, for example the patient 46 might be requesting extra medications, or the nurse 42 might have seen an important change in vital statistics, or the nurse 42 has noticed one of a hundred other scenarios. The nurse 42 first uses her wireless device 60 to confirm that the assigned doctor 52 is currently in the hospital 10. She might also be able to confirm that he is on floor 22 in zone 8. The nurse 42 then sends an Instant Message, Electronic Page or E-Mail message to the doctor 52 indicating exactly what the situation is. With this message the nurse 42 attaches the patient 46 information that was received when the nurse 42 entered zone 3. The doctor 52 then opens the message, reads the nurse's 42 request and can open the patient 46 record to help assess the situation and make the decision.

Thus even through the doctor 52 is not within the zone for the patent 46 he is able to receive the information to support his assessment of the patient's 46 condition. To help further automate the process it is also possible for the wireless device 60 to automatically associate all information for zone 3 to the message currently being entered. This is made possible as each patient's record in the database 28 has the admitting doctor's 52 name and information. This database 28 information might also include the Cardiac, Kidney and GI specialists, as well as the person's family doctor all named within the database record 28. Built right into the software logic on the wireless device 60, is a command to automatically send an urgent message to one of the assigned doctors 52. In this action the nurse 42 is acting as a local proxy for the information, whether she is aware of assigned doctors 52, or whether she is unaware; as it can be extracted from the patient's database record 28. In those situations where the nurse 42 does not know who the attending physician is, it is essential that she has the capabilities to open and address the stakeholders directly. There could be one or more doctors and in many cases, so the nurse 42 can pick one, or pick all of them to send the message to. In an exemplary embodiment the nurse can also see which of the stakeholders are in the hospital through the same zone tracking mechanism that is used to update each doctor's 52 wireless device 60.

Naturally the doctor 52 could have requested the record manually from the database 28 in the IT Center 24, but that would have taken more time and effort. Without the exemplary automation discussed, the nurse's 42 request and the patent's database record 28 would not have been so closely linked resulting in the doctor 52 having to perform many more steps to track down the record for that patient 46.

In another exemplary embodiment for FIG. 3 there is an example that uses a landline phone circuit 64. In this embodiment the nurse 40 does not have a wireless device 60, but still needs to reach the doctor 52. In this situation the nurse 40 picks up the bedside phone 64 in the patient's 44 room and dials the doctor 52. The Data Correlation Module 32 is able to monitor PBX traffic through the Phone Services 30 component within the IT Center 24 through the LAN 14 that runs between all the IT Center's 24 components. This kind of monitoring of phone circuits and local extensions is well known in the field of Phone Service 30 technology. The Data Correlation Module 32 knows that the call has been originated from Zone 1 that belongs to the patient's 44 bedside table. The nurse 40 ends up calling the doctor's 52 W-LAN wireless device 60, as the wireless device 60 is capable of both voice and data functions. When the Data Correlation Module 32 sees a call coming from the patient 44 room, to the attending doctor 52, and that the doctor 52 is in the hospital 10 with a wireless device 60, it immediately forwards the patient's 44 record to the doctor's 52 wireless device 60. In this way a physical device within Zone 1, other than another wireless device 60, is capable of triggering zone specific information to be sent to a doctor.

Once the doctor 52 receives the call from the nurse 40, he also receives the patient's 44 database record 28 on his wireless device 60 and is able to confirm what course of action should be taken. This immediate effect of giving the doctor 52 direct access to a database record 28 when he needs it saves time and improves the doctors 52 ability to make clear and accurate decision on behalf of patients.

FIG. 3 also provides another exemplary embodiment of the invention being used with a call button connect to the patient. This is similar to the previous embodiment except that the call button also goes to the nurse's station 50 first. In this embodiment the patient's 54 call button 56 is in her hand. When the patient 54 presses the button, the signal passes up the cord 56 through a connection in the wall 58. This connected 58 could travel to a centralized switch running to the nurse's station 50, or it could be connected 58 through the hospital LAN 14 to Computer Program 26 running in the IT Center 24. When the patient 54 calls for assistance the signal 58 goes to the nursing station 50 and also to the Data Correlation Module 32. The Data Correlation Module 32 receives the signal off the LAN 14, or through the nurse's station 50 that is also wired up to the LAN 14. Based on the fact that the call button is related to the bed owned by the patient 54, the Data Correlation Module 32 also sends the Patient's 54 record to the stakeholders of the patient 54. This could include a copy of the record to the attending nurse 48 in charge of the patient 54, or even the admitting doctor 52 if they are in the hospital 10. Alternatively it might be configurable to only send the information to either the nurse 48 or the doctor 52, but not both. In a exemplary embodiment this same configuration allows a standard message to be sent with the information, something like: “Urgent Care Patient Has Pressed Their Call Button”. In a likely scenario, only specialized and very needy patients receive the type of call buttons 56 that can perform this function. Otherwise the number of interruptions to doctors 52 could be too high. However, sending this information to a nurse 48 allows the nurse to spend less time at the nurse's station 50 and more time in other patient's rooms providing care. With this advanced functionality, the attending nurse 48 will always be confident that a pressed call button 56 will get their attention no matter where she is.

Naturally all these same scenarios and embodiments could also be used in many businesses and development centers. For example in a manufacturing company the floor supervisor or the plant manager could be considered similar to a doctor. The floor supervisor is the stakeholder who is taking the pulse of what is happening on the floor at any given point in time. In this alternative embodiment the floor supervisor or plant manager arrives into one of the buildings in the companies campus and gets immediate updates on specific machines, steps in the manufacturing process, part supplies and specific employee concerns, based on their location. Each time they walk to a different zone in the campus a new set of updates is brought to their attention. In a courier environment a similar ‘just-in-time’ notification of location specific information is also useful. The North American package manager might enter the Canadian delivery center and get an update on packages processed, outstanding issues and problems at that moment in time.

Referring now to FIG. 4 there is a graphical illustration of a sample database layout used for correlating data for delivery. For one skilled in the art it is obvious that there could be many possible database layouts and divisions. The following selection of databases 28 shows just one embodiment. In this embodiment the database 28 could be running a Cisco or Microsoft database program providing services to many programs on over the LAN 14. All of the computer programs 26 running in the hospital, including the Data Correlation Module 32 are making use of the database 28.

The most frequently used database would most likely be the patient record database 70. Within this record would be the patient's historical data, home address and contact information, their drug sensitivity, current assigned floor, room and bed number as well as the admitting doctor, their General Practitioner (GP) and the nurses that are assigned to them on their floor. There are many other fields in this database record 70, but the ones listed are most relevant to this application. Also saved in the database would be the W-LAN Access Locations record 72. This record 72 would have a list of every installed W-LAN access point 16, the floor it was one, perhaps the room it was installed in and the addressing information to access it. Addressing information could be the assigned IP address or some other media access control (MAC) level address information. Another database within the large database files 28 would be the hospital staff record 74. The hospital staff record 74 would contain all the known staff of the hospital, their position and role in the hospital, including doctors that had hospital privileges. Each hospital staff may also have various access rights depending on the available services within the hospital. Another database within the hospital might be the equipment and phone location record 76. This record 76 would hold the location of specific call buttons and phone extensions, based on room, floor and bed number.

By collecting data from various databases record 78 the Data Correlation Module 32 is able to build a correlation table 80. The correlation table 80 takes disconnected information and relates it in a specific way related to zones. In this record 80 there would be an assignment of zone Ids to W-LAN 16 coverage areas. Each W-LAN coverage area might be identified by a W-LAN assigned number or by its assigned address (IP address). This record 80 might also hold the floor and room numbers covered by this W-LAN zone to help with its correlation activities. To related databases to the data correlation database 80 are the Device Status and Location database 82 and the Stakeholder Status and Information database 84. These database (82, 84) are build to related to the data correlation record 80 and are updated as information changes moment by moment. Some of the fields in the device status and location record 82 would include, the status information for each device, including the zone it currently is located in, the floor it is located on and the status information. Status could include whether it was functional, currently had an assigned address, whether a user had logged into it, etc. Some of the field in the Stakeholder status and information record 84 would include the stakeholder name and access rights, the device they were currently logged into, the zone the stakeholder was last detected and their presence information. Presence information could include available, busy, out of coverage/roaming, do not disturb and several other possible settings. These various databases 28 together allow the Data Correlation Module 32 perform the function of tracking device 60 location and delivering data in a timely fashion to the interested stakeholder.

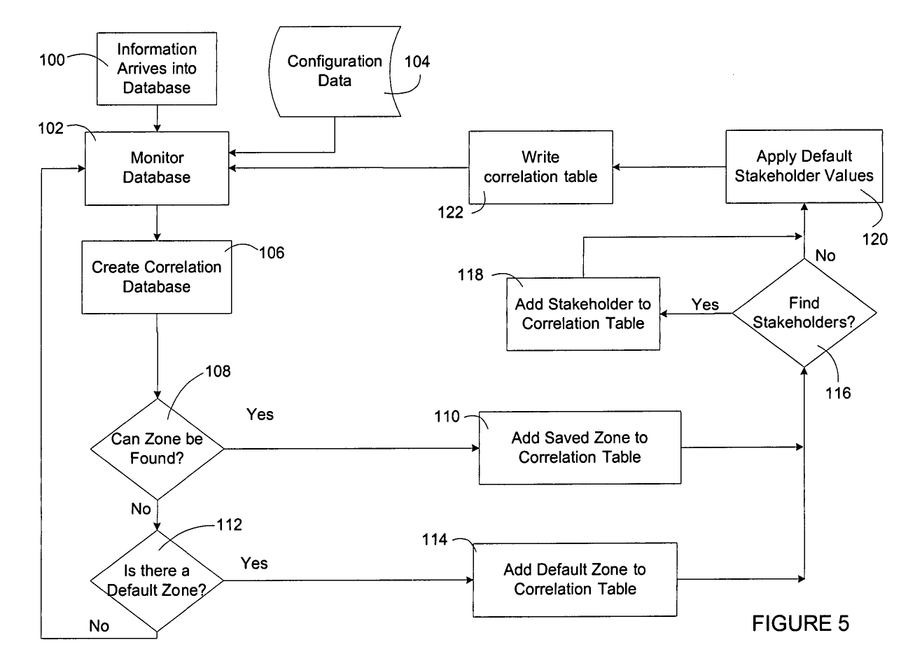

Referring now to FIG. 5 there is a flow chart depicting the preparation and pre-scanning done by the Data Correlation Module 32 (see FIG. 2) with the database information (see FIG. 4). This is a key aspect of the disclosure as the Data Correlation Module 32 must initially prepare the data correlation tables to allow for fast routing of information and data to the correct Stakeholders when they enter the appropriate zones.

The first step 100 occurs at startup or any time during operation when data is added to the database 28. The very first time the Data Correlation Module 32 is start it must review the database 28 looking at patient records to determine where the patient has been placed. At step 102 the Data Correlation Module 32 starts to track database 28 changes using callback procedures and other advanced database techniques. The process of monitoring is continuous and does not stop unless the program is stopped. Once stopped the data correlation tables are flushed to hard disk, as they would be periodically during normal operation. If the program is stopped and then restarted, it must read all information records that were added since the last time it was running. Within the stored record depicted by box 104 the Data Correlation Module 32 reads any configuration data needed for normal operation. Configuration file data could include value zone numbers and their corresponding W-LAN regions, valid stakeholders (doctors, nurses, Intervenous nurses, testing staff), default settings for zone and stakeholder behaviour and other user configurable values.

At step 106 each piece of information is given to the Data Correlation Module 32 to build a cross-reference database 28 to the original data. It must do this by taking a reference to the original database entry 28 and adding a zone identifier 34 and one or more stakeholder values (doctor 52 and nurses (40, 42 and 48). At step 108 as data is being prepared a check is performed to verify there is enough information to find the zone it should be assigned to. Normally, the hospital administrator that admitted the patient would have entered this information. In an exemplary embodiment the zone value is entered directly, alternatively the zone could be located by taking the hospital wing, floor, section and room number and cross referencing that to the configuration data for the known zones 108. At step 110 the zone can be determined, so the saved zone identifier is added to the correlation table entry being built. At step 112 there was no zone found, so a check is performed to see if a default zone can be applied to this database 28 entry. At step 114 if there is a default zone, this value can be added to the database 28 entry. If there is no default zone reference 112 (No), then the Data Correlation Module 32 returns to monitoring more data.

At step 116 the zone reference has been added and a further check is performed to see if stakeholders can be determined. The rules to apply stakeholders might be to scan the database record 28 for this patient and look for doctor information. Also, based on the zone, floor and wing in the hospital it would be possible to match this against nursing staff assigned to that region of the hospital. At 118 known stakeholders are found and applied to the data correlation table entry being built. At step 120, either after applying known stakeholders, or if no known stakeholders could be found, default stakeholders is always applied to the information. In the example of the hospital, this allows for specific doctors to be applied as stakeholders, and then default stakeholders like assistant floor nurses, registered nurses (RNs) and Intervenous (IV) nurses. At step 122 the new correlation table entry is complete and can be written to the database 28. It might also be cached in RAM for fast access when needed for zone movements. In many environments information starts out very actively accessed and it slowly reduces once the data has been around for a while. Once this is done the Data Correlation Module 32 returns to check for more information to access in the database 102.

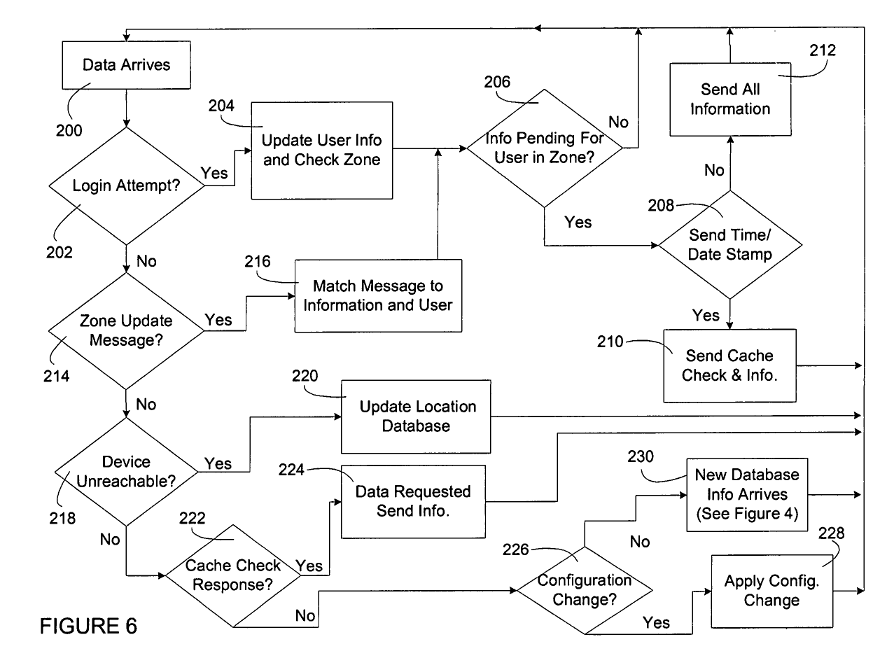

Referring now to FIG. 6 there is a flow chart depicting the basic operation of the Data Correlation Module 32 (see FIG. 2) with incoming events and data. This data flow diagram complements FIG. 5, and the operation works as part of the Data Correlation Module 32.

Starting from step 200 the Data Correlation Module 32 must process data that is arriving from various sources all the time. The data includes wireless device 60 data, it could also include PBX data (local phone extensions being used 64), call button data 56 and login data. There may be many other data sources but these are a representative illustration of several mentioned in this application. At step 202 the first checks shown is to see if a login has been attempted. When a Stakeholder logs into a wireless device 60 it affects status information within the correlation tables (see FIG. 4). At step 204 a login has been detected so the status table for stakeholders is updated, and the user's current zone (where they logged in) is checked against any available data for that zone. At this step there are also many other possible actions in the system. For example, the Data Correlation Module 32 would send out notifications to other wireless device 60 users to update the location and presence information for this stakeholder (i.e. wireless device 60 holder). Once these updates are performed, step 206 is performed to check for specific information available for that user. The user might have logged into a zone where stakeholder information is waiting for them. If there is no information waiting for them, there is nothing more to do with this login sequence. If there is information for the user, then at step 208 a check is preformed to see if date and timestamp caching is being performed. This could be a configurable item and the user might not want this functionality. In this embodiment the caching method used is an exchange of cache-update messages to maintain cache entries on each wireless device 60. At step 210 if caching entries are being used a message containing values like size, time and date of the zone information is sent. The cache update message could also contain an information tag or some other unique database identifier to label the information and match it against what is currently on the wireless device 60. At step 212, the caching message is not being used and therefore the full database record is sent to the wireless device 60.

Moving back to step 202, the test to see if the user has logged in we get to step 214 if the message received was not a login message. At step 214 there is a further check to see if a zone update message has been received. The zone update message could be from wireless device 60 or some other signal mechanism. As mentioned earlier this signal could be the wireless device 60 entering a zone, it could be a PBX phone 64 call being made to a stakeholder, or it could be a call button 56 being pressed by a patient 54. At step 216 it has been determined that the message is a zone update message. In this situation the Data Correlation Module 32 accesses the data correlation table (see FIG. 4) to extract the information necessary to make delivery decisions. With this information it then performs it's normal correlation process to see if the user logged into this wireless device 60 has actual information that should be sent to them while they are in the current zone. This process can use the cache update message as already described.

If the message is not a zone update message 214 then it could be a timeout signal that a wireless device 60 is unreachable. At step 218 a check is performed to see if the message is a timeout signal indicating the wireless device 60 is unreachable. In this situation the polling mechanism being used to keep in touch with each wireless device 60. This mechanism is just one common method for determining that a wireless device 60 is unreachable. At step 220 the change in state information is saved in the user state database and a message is sent to all other wireless devices 60 that are tracking the presence information of this user.

If the message was not a timeout message 218 a further check is performed to see if a cache response message was received. At step 222 the Data Correlation Module 32 checks to see if the wireless device 60 has returned a cache check response. A cache check response is sent from the wireless device 60 only when it needs to get an updated copy of the information. At step 224 the message was a cache check response and the Data Correlation Module 32 sends the entire record as requested. Otherwise, at step 226 a final check is made to see if a configuration change has been received. If a configuration change is present we proceed to step 228 where the Data Correlation Module 32 is updated with any configuration changes.

If the message is not a configuration change, at step 230 the final step is to check for database information changes. If the message is a new database entry (i.e. a patient record, a new piece of machine, etc) the flow chart in FIG. 4 describes how the data correlation table is updated to reflect the new information or configuration data.

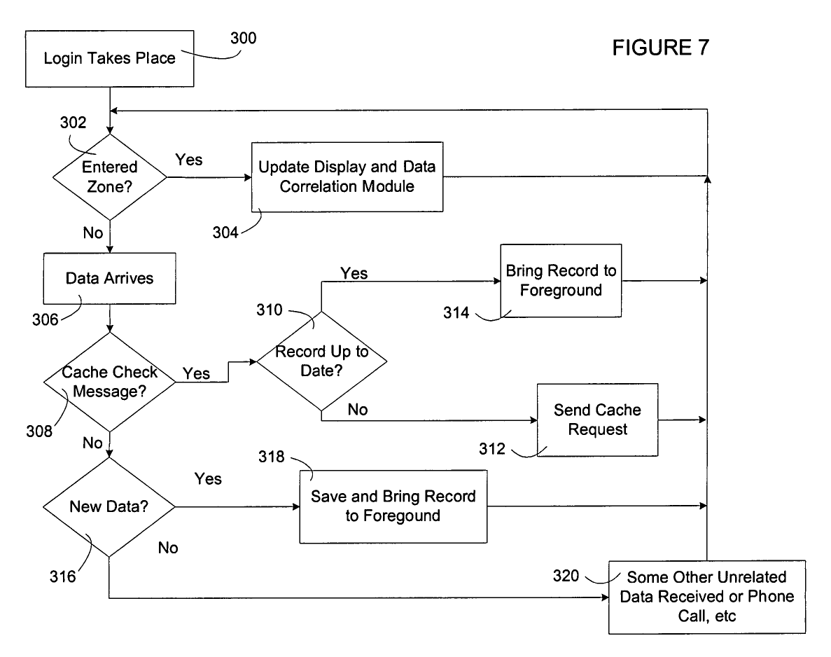

Referring now to FIG. 7 there is a flow chart of depicting the basic operation of the wireless device 60 with incoming events and data. The process starts at step 300, where the wireless device 60 requires a user to login in order to authenticate them. This could involve advanced public key infrastructure, security database checks, shared key exchanges, MD5 challenge/response messages or even a simple user-id and password exchange with the Data Correlation Module 32. In a exemplary embodiment a login/password exchange will take place with the Data Correlation Module 32.

At step 302 the user has logged in and a check is performed to see if the user has entered a new zone. Each new coverage zone the user enters is sent to the Data Correlation Module 32 for processing. At step 304 if the wireless device 60 has entered a new coverage zone it updates the display and sends the new coverage information to the Data Correlation Module 32. This action occurs often and is performed by monitoring the coverage zone environment around the wireless device 60. This could be run from a timer on the wireless device 60, or a signal might be generated at the W-LAN radio layers to inform the application when a new W-LAN Access Point 16 has been detected.

If the zone hasn't changed 302, at step 306 it is assumed that physical data has arrived for the wireless device 60. For this data flow it is assumed that the data is from the Data Correlation Module 32. At step 308 a check is performed to see if the data is an information cache check message. At step 310 the message is confirmed to be a cache-check message and so the wireless device 60 checks to see if the corresponding record on the wireless device 60 is up-to-date. At step 312 if the record is not up-to-date, it sends a cache failure response to the Data Correlation Module. At step 314 if the cache is up-to-date with the latest record, the record is brought to the foreground for the user to see.

If the information is not a cache check message 308, at step 316 a check is performed to see if a new record for the current zone, as been received by the wireless device 60. At step 318 there is new information for the user based on the zone they have just entered or some automatic update of zone information. The wireless device 60 checks the cache for space and updates the cache as needed. If space is required a cache update process is undertaken to purge the oldest and least used records. This cache update process will follow whatever well-known cache update logic has been implemented. Once saved, the process brings the data record to the foreground so it is clear to the user which information has changed. If there are several new pieces of data in this zone it will provide a convenient list of choices for the stakeholder. At step 320 if the message is not actual zone data then it could be another event like a phone call, configuration data or some other relevant data for this wireless device 60.

The invention has been described with reference to several preferred embodiments. Those skilled in the art will consider improvements, changes and modifications in view of the foregoing description. Such improvements, changes and modifications are intended to be within the scope of the claims.

I claim:

1. A system for correlating data into W-LAN zones comprising:
a W-LAN access point located within each of said zones;
a data correlation module for categorizing information into related W-LAN zones; and
a monitoring process actively connected to each of the W-LAN zones, said monitoring module tracking activity within each of the said zones.

2. A system of claim 1 further comprising a data delivery module to transmit the categorized data by utilizing said W-LAN access points.

3. The system of claim 2 wherein the data delivery module can receive categorized data from a W-LAN access point and forward it to another W-LAN access point.

4. The system of claim 1 further comprising a database of categorized data that is also related to specific stakeholders of the data.

5. The system of claim 1 wherein the activity being detected is the arrival and departure of wireless devices into the said zones.

6. The system of claim 5 wherein the transmission of the categorized information is automatic when a stakeholder of the data enters the said zone.

7. The system of claim 6 wherein the data is automatically updated to the stakeholder when the categorized information changes and the stakeholder is still in the related W-LAN zone.

8. The system of claim 1 wherein the data correlation module uses W-LAN installation locations to categorize the original data to be delivered to the said stakeholders.
